(19) United States
(12) Patent Application Publication
(10) Pub. No.: US 2004/0007426 A1
(43) Pub. Date: Jan. 15, 2004

(54) Lubrication system with pressure equalization

(76) Inventors: Bernhard Keller, Wasserlosen-Kaisten (DE); Rudolf Schlereth, Frauenroth (DE); Roland Greubel, Ramsthal (DE)

Correspondence Address: STRIKER, STRIKER & STENBY, 103 East Neck Road, Huntington, NY, 11743, US

(21) Appl. No.: 10/435,951

(22) Filed: May 12, 2003

(30) Foreign Application Priority Data
May 14, 2002 (DE) 102 21 410.7

(51) Int. Cl. F16N 1/00

(52) U.S. Cl. 184/5

(57) ABSTRACT

A linear device (10) includes a driver, which is arranged to be moveable back and forth along a drive track, and at least one lubricating device (28) non-moveably connected with the driver. The lubricating device (28) has at least one lubricating element (32) that is in lubricating contact with the drive track and at least one lubricant reservoir (34). At least one functional device (34) is provided, which maintains the pressure in the lubricant reservoir at a constant value.

### BACKGROUND OF THE INVENTION

The present invention relates to a linear device with a driver, which is arranged to be moveable back and forth along a drive track, and with at least one lubrication device non-moveably connected with the driver, which has at least one lubricating element in lubricating contact with the drive track and at least one lubricant reservoir. The invention also relates in particular to a further development of the lubricating device of the linear device known from DE 100 26 238 A1. Therefore, the disclosure of DE 100 26 238 Al is incorporated by reference herein and is made a part of the disclosure of the present application.

In practice, it has been shown that with the linear device known from DE 100 26 238 A1, the lubricant is not provided with the uniformity sufficient for the high quality specifications of the Applicants. In addition, an unwanted oscillation of the lubricating means dispenser takes place.

It is therefore an object of the present invention to provide a linear device of the above-described type, with which the lubricant is released with a more constant dispensing apparatus.

### SUMMARY OF THE INVENTION

This object is solved according to the present invention with a linear device of the above-described type, with which at least one functional unit is provided, which holds the pressure in the lubricant reservoir essentially at a constant value. The invention is based on the following understanding: With this type of lubricating device, a negative pressure is formed in the lubricant reservoir by the suction action of the lubricating element, which transfers the lubricant onto the lubricated surfaces. By means of this negative pressure, the lubricating device only dispenses lubricant in operation, while in a non-operation state of the linear device, no lubricant is dispensed. With current lubricant dispensers, the negative pressure in the lubricant reservoir first keeps increasing, and at a random point in time, arrives at a more or less marked pressure equalization with a subsequently higher lubricant dispenser. The present invention provides that in the pressure in the lubricant reservoir essentially is no longer subject to fluctuations, so that the lubricant is dispensed in operation of the linear device with an essentially constant rate.

In order to prevent contaminating the entire assembly in which the linear device is installed with lubricant, it can be provided that the functional device allows the entry of air from the surrounding environment, which prevents the discharge of lubricant from the lubricant reservoir. In view of the fact that a negative pressure exists in the lubricant reservoir, the functional unit, then, can be formed with a repulsion function.

In a further form of the invention, it is proposed that the functional device is arranged in a receiving passage of a wall limiting the lubricant reservoir. In this manner, the functional device can be secured in this receiving passage n a simple manner by means of an assembly bushing.

With a linear device with a worm drive, in which a nut of the driver surrounds a worm threaded spindle representing the drive track and also the lubricant reservoir surrounds at least a part of the circumference of the threaded spindle and is arranged radially outside of the lubricant element, at least one receiving passage can be provided in one wall limiting the lubricant reservoir radially inward. In this manner, in a simple manner, an unintended discharge of lubricant with the result of contaminating the entire linear device and its surroundings is prevented. With an unintended discharge of lubricant radially inward, this lubricant moves to the threaded spindle and from this, by means of the commonly provided devices for clearing away dirt and/or an excess of lubricant is further removed. Alternatively, however, it is possible that at least one receiving passage is a passage running essentially in the direction of the spindle axis.

According to a first alternative embodiment, the functional device can be formed as a return valve, which connects the lubricant reservoir with the surrounding environment. The return function can be realized in that the return valve has an opening defines by an elastic material, which normally is closed based on the elasticity of the material, but which, however, opens upon exceeding of a predetermined pressure difference. As the elastic material, preferably rubber or a rubber-like material can be used. The opening, preferably formed as a slit, can be provided in a closed end of an essentially tube-shaped section of the return valve, for example.

In order to be able to form the valve in a constructively simple manner as a return valve, the essentially tube-shaped section can taper in an extension direction that runs orthogonal to the tubular axis. Minimal manufacturing costs of the valve can be ensured, therefore, in that the valve is formed completely from an elastic material. For the return function, it is also advantageous if the valve is arranged in the receiving passage, such that the opening is directed at the lubricant reservoir.

According to a second alternative embodiment, the functional device can have a semi-permeable membrane, that is, a membrane, which is permeable for air but impermeable for lubricant.

Finally, the functional device can be an elastic membrane, which defines the lubricant reservoir at least partially and whose surface facing away from the lubricant reservoir is connected with the surrounding environment. With increasing lubricant dispensing, this membrane deforms in the sense of a decrease of the storage volume of the lubricant reservoir. The elasticity of the membrane sees to the negative pressure, which is necessary in order to ensure that the lubricant is dispensed only in operation of the linear device. By tensioning of the elastic membrane, the amount of the pressure in the lubricant reservoir can be adjusted to a desired value, on the one hand, and on the other hand, it can be ensured that the value of the negative pressure during the course of the lubricant dispensing is not changed or only insignificantly changed.

### BRIEF DESCRIPTION OF THE DRAWINGS

FIG. 1 is a rough schematic, not-to-scale sectional view of the basic parts of the linear device;

FIG. 2 is a sectional view of a first embodiment of the linear device of the present invention;

FIG. 3 is a perspective explosion illustration of the linear device according to FIG. 2;

FIG. 4 is a schematic plan view of a valve element of the embodiment of FIGS. 2 and 3;

FIG. 5 is a sectional view of the valve element according to FIG. 4 along the line V-V in FIG. 4;

FIG. 6 is a schematic sectional view of a part of a second embodiment of a linear device according to the present invention; and

FIG. 7 is a schematic sectional view of a part of a third embodiment of a linear device according to the present invention.

### DETAILED DESCRIPTION OF THE PREFERRED EMBODIMENTS

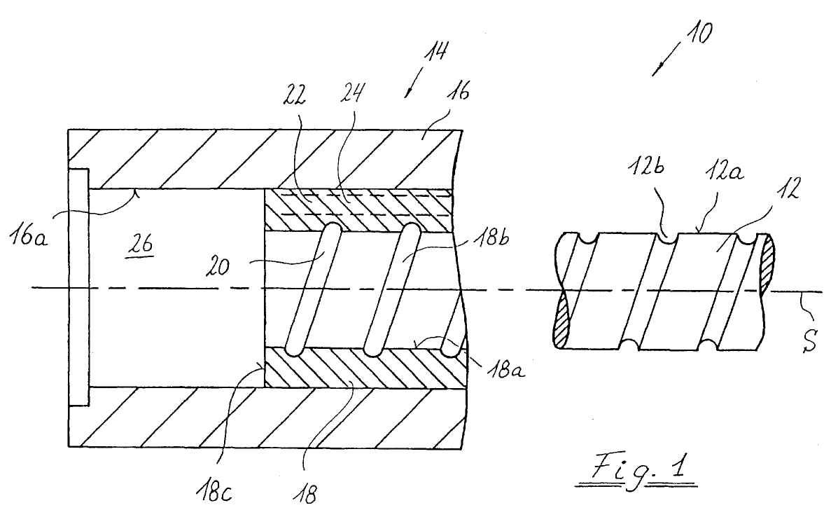

In FIG. 1, a rolling element worm gear for a linear unit according to the present invention is designated generally with reference numeral 10. It includes a threaded spindle 12 with a spindle axis S and a guide carriage 14 on the threaded spindle 12 that is drivable back and forth in the direction of the spindle axis S. The guide carriage 14 serves for applying a functional device (not shown) that can be positioned by means of the rolling element worm gear 10. The guide carriage 14 includes a guide carriage main part 16 and a nut device 18 formed separately from the guide carriage main part 16, which is inserted non-rotatably in an axial passage 16a of the guide carriage main part 16.

In the outer circumferential surface 12a of the threaded spindle 12, at least one spindle groove 12b is formed. According to the number of the screw-type spindle grooves 12b running into one another, the threaded spindle 12 operates as a one or more-gear threaded spindle. In the inner circumferential surface 18a of the threaded nut device 18, a corresponding number of counter spindle grooves 18b are formed, which together with the spindle grooves 12b of the threaded spindle 12, form a threaded channel 20, which like the return channel 22 shown in dashed lines in FIG. 1, is part of an unless circumferential channel 24, in which a plurality of rolling elements, preferably spheres (not shown in FIGS. 1) is arranged.

Ina known manner, the guide carriage 14 is guided to a profile bar (not shown), which is braced to transmit a load on a guide housing, so that the nut device 18 transfers no or almost no load onto the threaded spindle 12 and with reference to the spindle axis S, is non-rotatably, which is supported in end pieces (not shown) of the guide housing to be rotatable about the spindle axis S. In this manner, a rotation of the threaded spindle 12 about the spindle axis S can be converted into a linear movement of the guide carriage 14.

As one can see further from FIG. 1, space 26 is available with the rolling element worm gear 10 in the region of the left axial end of the guide carriage main part 16 bordering on the front face 18c of the threaded nut device 18, which is used for receiving a lubricating device 28, whose structure will be described in greater detail with reference to the next figures:

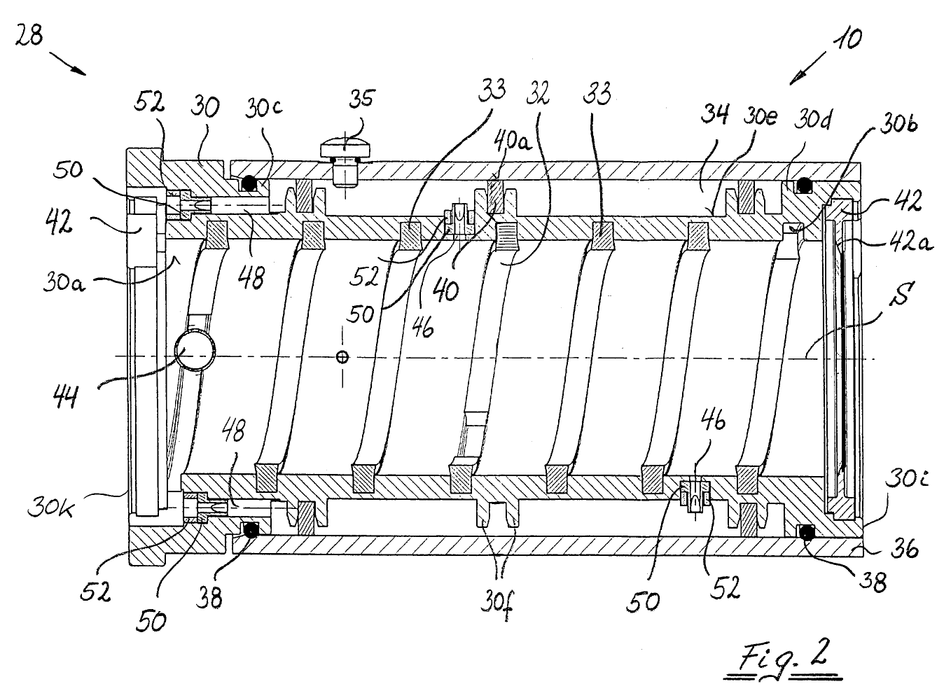

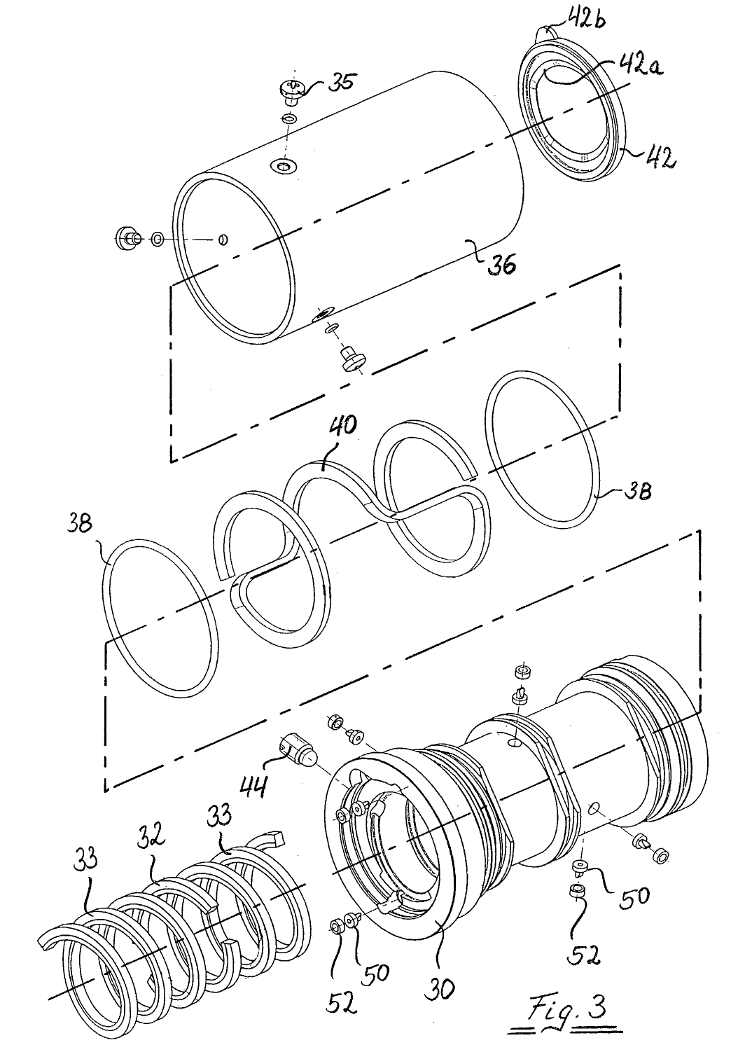

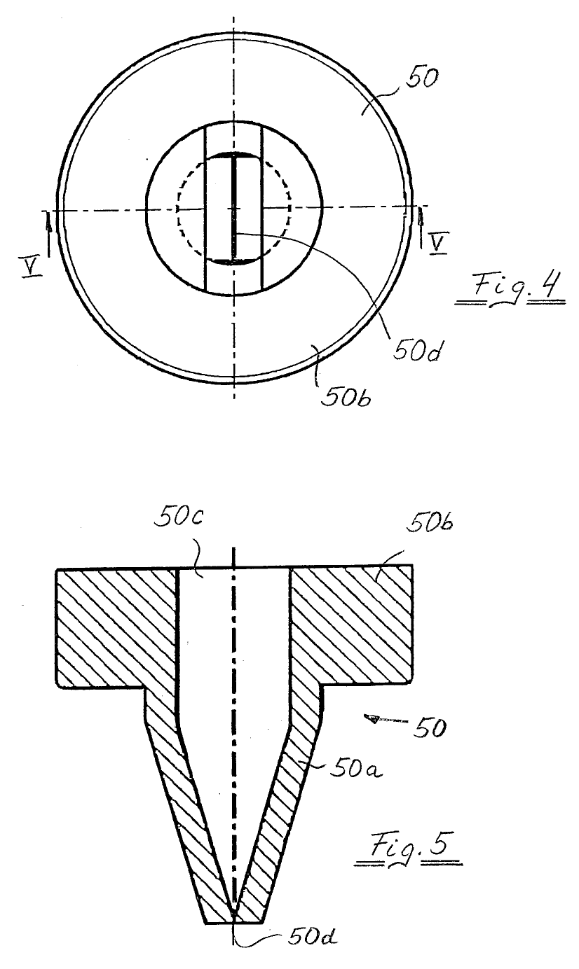

According to FIGS. 2 and 3, the lubricating device 28 includes a base body 30, on whose inner circumferential surface 30a, a helical groove 3b is provided. In the helical groove 3b, screw-type elements, for example, made from felt or the like, are arranged. From these screw-type elements, the element 32 is a lubricating element, while the elements 33 arranged in the direction of the spindle axis S in front or and/or behind the lubricating element 32 are stripping elements. These stripping elements 33 have the purpose of protecting the lubricating element against dirt particles, which can enter in the area of the lubricating device 28. In addition, the elements 33 have the purpose of re-collecting the lubricant that runs off from the threaded spindle 12, in order to ensure its uniform lubrication.

On the outer side of the base body 30, a lubricant reservoir 34 is formed. The base body 30 includes annular projections 30c and 3c in the region of its two longitudinal ends, which project out in a radial direction over the essentially cylindrical outer circumferential surface 30e of the bas body. On these annular projections 30c and 30c, a cover bushing 36 is loaded, so that in cooperation with sealing rings 38, a closed hollow chamber for the lubricant reservoir 38 is formed. In addition, a closure screw 35 for an inlet opening for filling the lubricant reservoir 34 with lubricant, preferably lubricant oil, is shown.

Also in the area of the longitudinal center of the base body 30, two annular ribs 30f are formed, which extend in a radial direction outer circumferential surface 30e of the base body 30, however, not so far as the annular projections 30c and 30d. In the annular groove 30g limited by these two annular ribs 30f, a lubricant suction element 40 is provided, which rests with its outer circumferential surface 40a on the inner surface of the cover bushing 36. On the inner circumferential surface 40b of the lubricant suction element 40, a wick (not shown) is provided, which penetrates a radial passage of the base body 30 and contacts the outer circumferential surface of the screw-shaped lubricating element 32. In this manner, the lubricant can be guided from the lubricant reservoir 34 to the lubricating element 32. This wick can be made as a wick projection of the suction element 40 or as a pat formed separately from the suction element 40 and can be inserted into the connection opening. In addition, instead of the wick, a membrane device can be arranged in the passage, which allows passage of lubricant only in one direction, namely, from the reservoir 34 to the lubricating element 32, that is, it operates as a type of return valve.

In order to prevent a discharge of lubricant from the region of the lubricating device 28, in the area of the longitudinal ends 30i and 30k of the base body 30, sealing devices 42 with inner sealing lips 42a are provided. An outer nose 42b (FIG. 3) ensures the maintenance of the desired relative rotational position between the sealing device 42 and the threaded spindle 12.

According to FIG. 2, in the region of the longitudinal ends 30k of the base body 30, in this base body a locking pin 44 additionally is screwed in, whose radial inner end is predetermined for engagement in a spindle groove 12b of the threaded spindle 12 and so the desired relative position of the base body 30 and, therewith, the entire lubricating device 28, is secured with reference to the threaded spindle.

Finally, in the base body 30, a plurality of passages 46 and 48 are provided, of which the passage 46 extends in a radial direction with reference to the spindle axis S and the lubricant reservoir 34 is connected with the inner circumferential surface 30a of the base body 30, and of which the passage 48 extends in the axial direction. Each of these passages 46, 48 is widened on one of its ends. In each of these passages 46, 48, a valve element 50 is inserted. The valve elements 50 include a shaft 50a, a widened head part 50b and an axial passage 50c, which is narrowed on the free end of the shaft 50a to a slit 50d. The valve element 50 is made of rubber or a rubber-like material. The end of the shaft 50a having the slit 50d, in addition, is designed so that the slit 50d normally is closed, based on the elasticity of the material of the valve element 50, but when a predetermined pressure difference between the pressure in the passage 50c and the pressure of the surrounding environment is exceeded, the slit 50d opens.

The valve element 50 is inserted with its widened head 50b into the widened section of the passage 46, 48, whereby the shaft 50a, respectively, points to the lubricant reservoir. The valve elements 50 are secured in the passages 46, 48 by mounting bushings 52, which are inserted in the widened sections of these passages in a press-fit after insertion of the valve elements 50 into the passages 46, 48. As can be seen from FIG. 2, the outer diameter of the shaft 50a has an insignificantly smaller value than the inner diameter of passages 48 or the mounting bushings 52.

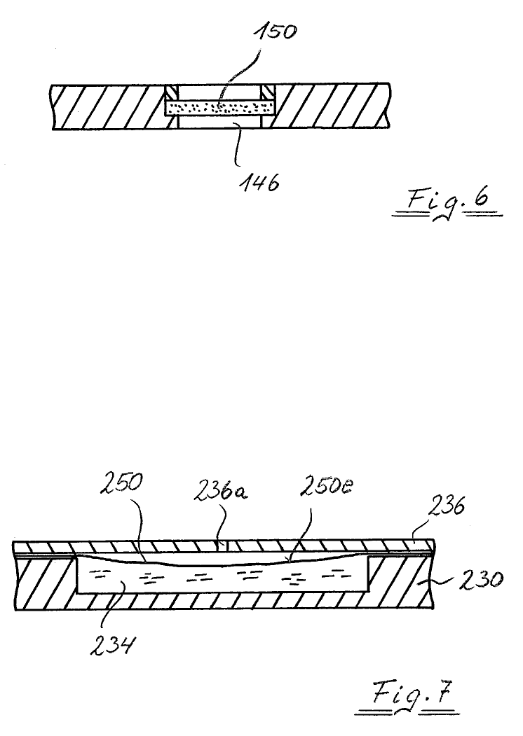

As an addendum to the previous explanation of an embodiment, in which the functional devices are formed from return valves 50, it should be noted that additionally or alternatively, also functional devices can be provided, which, according to FIG. 6, are formed as semi-permeable membranes 150, that is, as membranes that are permeable to air but are impermeable to lubricant. Although the membrane 150 illustrated in FIG. 6 is provided in a radial passage 146, of course, also the membrane can be accommodated in an axial passage, similar to the passage 48 of the preceding embodiment.

According to FIG. 7, the functional device can be formed as an elastic membrane 250, which is tensioned between the base body 230 and the cover bushing 236. The back side 250e of this membrane 250 is connected with the surrounding environment via a passage 236a of the cover bushing 236 and therewith, is pressurized with atmospheric pressure. The pressure difference between the negative pressure in the lubricant reservoir 234 and the atmospheric pressure is therefore equalized by means of the elasticity of the membrane 250.

If, in connection with the present invention, a “substantially constant pressure” is intended, then this is to be understood that the valve opens with a first, predetermined pressure in the lubricant reservoir and with a second, predetermined pressure in the lubricant reservoir, again closes, whereby the pressure difference between the first and the second predetermined pressure has the smallest possible value.

It will be understood that each of the elements described above, or two or more together, may also find a useful application in other types of constructions differing from the types described above.

While the invention has been illustrated and described herein as a lubricating device with pressure equalization, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A linear device (10), including:
a driver (14), wherein said driver (14) is arranged to be moveable back and forth along a drive track; and
at least one lubricating device (28) non-moveably connected with the driver (14), wherein said lubricating device (28) has at least one lubricating element (32) that is in lubricating contact with the drive track and at least one lubricant reservoir (34),
characterized in that at least one functional device (50) is provided, wherein said functional device (50) maintains a pressure in the lubricant reservoir (34) essentially at a constant value.

2. The linear device according to claim 1, characterized in that the functional device (50) permits entry of air into the lubricant reservoir from a surrounding environment and prevents the discharge of lubricant from the lubricant reservoir.

3. The linear device according to claim 1, characterized in that the functional device (50) is arranged in a receiving passage (46, 48) of a wall limiting the lubricant reservoir (34).

4. The linear device according to claim 3, characterized in that the functional device (50) is secured in the receiving passage (46, 48) by means of a mounting bushing (52).

5. Linear device with a spindle drive, in which a nut (18) of the driver (14) surrounds a threaded spindle (12) representing the drive track and also the lubricant reservoir (34) surrounds the threaded spindle (12) at least on a part of its circumference and is arranged radially outside of the lubricant element (32), according to claim 3, characterized in that at least one receiving passage (46, 48) is provided in a wall that radially inwardly defines the lubricant reservoir (34).

6. Linear device according to claim 3, characterized in that at least one receiving passage (46, 48) is a passage running in a direction of a spindle axis (S).

7. Linear device according to claim 1, characterized in that the functional device is a return valve (50), wherein the return valve (50) connects the lubricant reservoir (34) with the surrounding environment.

8. Linear device according to claim 7, characterized in that the return valve (50) has an opening (50d) that is defined by an elastic material, wherein normally the opening (50d) is closed based on the elasticity of the material, and wherein the opening (50d) opens when a predetermined pressure difference is exceeded.

9. Linear device according to claim 8, characterized in that the opening, preferably formed as a slit (50d), is provided in a closed end of a substantially tube-shaped section (50a) of the return valve (50).

10. Linear device according to claim 9, characterized in that the substantially tube-shaped section (50a) tapers at least in an extension direction running substantially orthogonally to a tubular axis.

11. Linear device according to claim 7, characterized in that the return valve (50) is formed substantially completely from an elastic material.

12. Linear device according to claim 3, characterized in that the return valve (50) is arranged in the receiving passage (46, 48), such that the opening (50d) is pointed at the lubricant reservoir (34).

13. Linear device according to claim 1, characterized in that the functional device has a semi-permeable membrane that is permeable to air but impermeable to lubricant.

14. Linear device according to claim 1, characterized in that the functional unit is an elastic membrane that at least partially defines the lubricant reservoir and wherein a surface of the function unit that faces away from the lubricant reservoir is connected with the surrounding environment.
